(19) United States
(12) Patent Application Publication
(10) Pub. No.: US 2021/0083483 A1
(43) Pub. Date: Mar. 18, 2021

(54) GAS TURBINE - ENERGY STORAGE HYBRID SYSTEM DESIGN

(71) Applicant: Wärtsilä North America, Houston, TX (US)

(72) Inventor: Sen Zhang, Houston, TX (US)

(73) Assignee: Wärtsilä North America, Houston, TX (US)

(21) Appl. No.: 16/955,709

(22) PCT Filed: Dec. 27, 2018
(86) PCT No.: PCT/US2018/067647

§ 371 Date: Jun. 18, 2020

Related U.S. Application Data
(60) Provisional application No. 62/611,787, filed on Dec. 29, 2017.

(51) Int. Cl. H02J 3/46; H02M 7/42; F02C 6/02; F02C 6/14

(52) U.S. Cl. CPC H02J 3/46; H02M 7/42; F05D 2220/762; F02C 6/14; F05D 2220/32; F02C 6/02

(57) ABSTRACT

A hybrid power system, includes at least one first isolation transformer having an input configured to be connectable to an output of a power supply; an energy storage system having at least one energy storage device and a power conversion system having at least one DC-to-AC converter connected to the at least one energy storage device; and at least one second isolation transformer configured as a step-up isolation transformer having an input connected to an output of the storage system.

### CROSS-REFERENCE TO RELATED APPLICATIONS

This application is related to and claims the benefit of U.S. Provisional Application No. 62/611,787 filed on Dec. 29, 2017, the contents of which is incorporated by reference in its entirety.

### FIELD

The present disclosure relates to energy production and storage systems.

### BACKGROUND INFORMATION

Energy production and storage systems are known, For example, U.S. Patent Publication No. 2017/0331298, the contents of which are incorporated by reference in their entirety, discloses various embodiments which include systems and methods of operating a hybrid energy system that includes a gas-turbine generator configured to provide a full-load power output and a storage device configured to store energy. The hybrid energy system includes a generator step-up transformer, wherein the gas-turbine generator and the storage device are electrically co-located on a low side of the generator step-up transformer. Methods of operation include controlling power output from the storage device and/or the gas-turbine generator during scheduled and unscheduled grid power demands to achieve economic and environmental performance advantages.

### SUMMARY

A hybrid power system is disclosed, comprising: at least one first isolation transformer having an input configured to be connectable to an output of a power supply; an energy storage system having at least one energy storage device and a power conversion system having at least one DC-to-AC converter connected to the at least one energy storage device; and at least one second isolation transformer configured as a step-up isolation transformer having an input connected to an output of the storage system.

A method is also disclosed for providing power, the method comprising: generating AC power via an AC power supply; supplying the power via at least a first isolation transformer to an output node; storing energy in an energy storage system as DC voltage; supplying power from the energy storage system to the output node via a DC-to-AC converter and a step-up isolation transformer, the energy storage system, DC-to-AC converter and step-up isolation transformer being connected in parallel with the AC power supply and first isolation transformer to the output node; and controlling the AC power supply and the energy storage system to regulate a power supplied to the output node.

A control unit for controlling a hybrid power system is also disclosed, comprising: a communication interface; at least one processor; and at least one memory including computer program code. The at least one memory and the computer program code can be configured to, with the at least one processor, cause the control unit to: generate AC power via an AC power supply; supply the power via at least a first isolation transformer to an output node; store energy in an energy storage system as DC voltage; supply power from the energy storage system to the output node via a DC-to-AC converter and a step-up isolation transformer, the energy storage system, DC-to-AC converter and step-up isolation transformer being connected in parallel with the AC power supply and first isolation transformer to the output node; and control the AC power supply and the energy storage system to regulate a power supplied to the output node.

### BRIEF DESCRIPTION OF THE DRAWINGS

Other features and advantages of the present disclosure will become more apparent upon reading the following detailed description in conjunction with the accompanying drawings, wherein like elements are designated by like numerals, and wherein:

FIG. 1 shows an exemplary hybrid power system that couples a power supply (e.g., gas turbine generator) with an energy storage system at a high voltage side of isolation transformers onto a medium voltage (e.g., 2 kV or lesser to 35 kV or greater) AC bus to, for example, achieve higher performances and lower operation costs;

FIG. 2 shows a block diagram of an exemplary communication network architecture that can be used for an embodiment of a control unit to, for example, facilitate controlling aspects of an embodiment of the hybrid power system; and

FIG. 3 shows an exemplary flow diagram that can be used by an embodiment of the control unit to, for example, control aspects of an embodiment of the hybrid power system.

### DETAILED DESCRIPTION

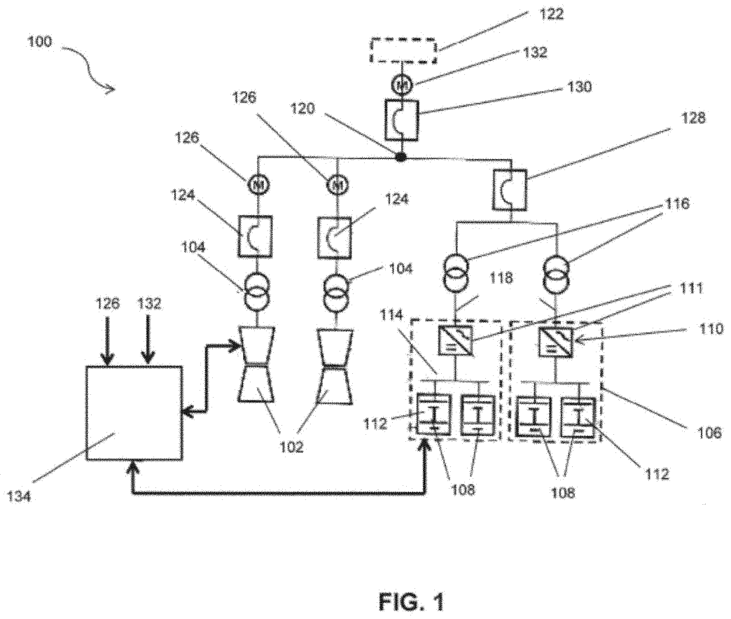

FIG. 1 shows an exemplary hybrid power system 100 that couples a power supply 102, such as one or more gas turbine generators with an energy storage system 106 at a high voltage side of one or plural, parallel isolation transformers 104 onto a medium voltage AC bus 126 (e.g., 2 kV to 35 kV) to, for example, achieve higher energy supply/load performances and lower operation costs.

Where a plurality of gas turbine generators (GTG) 102 are provided, each such generator is connected to the medium voltage AC bus 126 via an isolation transformer 104. Each GTG 102 can be isolated from the medium voltage AC bus 126 by a protection switch 124, and each GTG 102 can be individually metered to manage power produced thereby and operating conditions.

One or a plurality of battery energy storage systems (BESS) 106 can also be provided. Each BESS 106 can include a power conversion system (PCS) and one or a plurality of battery strings 108 that are connected in parallel on a common DC bus 114. Each battery string 108 can include a plurality of battery modules 122 that are connected in series.

In the exemplary FIG. 1 embodiment, the power conversion system 110 of a battery energy storage system 106 is connected to low (or medium) voltage AC bus 118 (e.g., less than 2 kV or other suitable voltage), then to a step-up isolation transformer 116, then to the medium (or high) voltage AC bus (e.g., at a voltage higher than 2 kV). A group of battery energy storage system units can be isolated from the medium voltage AC bus 126 via a protection switch 128, which switch can be configured in known fashion.

The hybrid system 100 can be connected to a load 122, such as a public or other utility grid 122. It can be isolated from the grid via a site protection switch 130 of known configuration. The entire system 100 can metered by a site meter 132 at a point of common coupling.

The hybrid system 100 can also form its own microgrid, and in such a case, it can be connected to load 122.

The FIG. 1 embodiment will now be described in greater detail.

At least one first isolation transformer 104 has an input (e.g., low side voltage of a step up transformer) configured to be connectable to an output of the power supply 102.

An energy storage system 106 having at least one energy storage device 108, and a power conversion system 110 having for example, at least one DC-to-AC converter 111, are connected to the at least one energy storage device 108. Each energy storage device 108 can, for example, be one or more parallel battery(s) and/or battery string(s) (e.g., of series connected batteries) having one or more battery modules 112 connected to a battery DC bus 114. Other suitable storage devices can, of course, be used, such as capacitors (e.g., medium or high voltage capacitors) to provide sufficient voltage for the low voltage AC bus (e.g., less than 2 kV).

At least one second isolation transformer 116 configured as a step-up voltage isolation transformer 116 has a low voltage side input connected to an output of the energy storage system 106. For example, each step-up voltage transformer 116 is connected to a low voltage AC bus 118 at an output of each DC-to-AC converter 111.

The hybrid power system 100 as illustrated can include a power supply 102 for generating AC power.

As already mentioned, the power supply 102 can for example be a gas turbine generator, or plural gas turbine generators connected in parallel, or any other suitable power generator system or device. Each gas turbine generator 102, or GTG, can for example, ramp up from a 0 MW condition to satisfy a full load condition of 50 MWs or 100 MWs, or lesser or greater. The first isolation transformer 104 can step-up the voltage is desired to any suitable voltage for supply of desired power to the load 122.

The at least one first isolation transformer 104 can include plural isolation transformers 104, each of the isolation transformers 104 being connected to one of the plural gas turbine generators 102, respectively in parallel.

The energy storage system 100 can include plural energy storage devices 108, each of the plural energy storage devices 108 including at least one battery module 112 as already noted.

The at least one second isolation transformer 116 can include plural isolation step-up voltage transformers 116, each of the plural isolation step-up transformers 116 being connected to one of plural DC-to-AC converters 111 of the energy storage system 106. The energy storage system 106 can for example, provide an output voltage that is independent of the power supply voltage and thus, via the step-up voltage transformer 116, step-up the output to the same voltage as is output from the voltage transformers 104 to meet a power demand of the load 122 (e.g., 50 MW).

An output node 120 can be provided as a connection for connecting an output of the first isolation transformer(s) 104 and a parallel output of the second isolation transformer(s) 116 (e.g., the node 120 is a power utility grid, or connects a grid, or to a load 122 in a microgrid site isolated from a public utility grid).

The output node 120 is a connection for supplying power of the hybrid power system 100 to a load 122, which can for example be a power utility grid, via a medium voltage AC bus 126.

The hybrid power system 100 can include a power supply feeder protection switch 124 and a meter 126 connected in series between an output of the at least one first isolation transformer 104 and the output node 120.

The hybrid power system 100 can include an energy storage feeder protection switch 128 connected in series between an output of the at least one isolation step-up voltage transformer 116 and the output node 120.

The hybrid power system 100 can include a site protection switch 130 and a site meter 132 connected to an output at the output node 120, in series between the output node 120 and the load 122. Each of the protection switches 124, 128, 130 can be, for example, known relay or other suitable devices that allow for overcurrent, overvoltage and/or overpower conditions to be monitored and controlled to protect the system 100 as desired (e.g., by tripping to an open circuit condition upon a given threshold) and/or to provide isolation.

The hybrid power system 100 can include a control unit 134 for controlling outputs of the power supply 102 and the energy storage system 106 via bidirectional and control lines. For example, the control unit 134 can regulate output power supplied from the power supply 102 and/or the energy storage device 106 using for example known feed-forward and/or feedback loops based on, for example load conditions, state of charge of battery modules 112, desired control of the gas turbine, and desired ramp rate of the desired output to be supplied to the load 122. The meters 126 can be, for example, provide voltage, current and/or power feedback, as can the site meter 132 for controlling power supplied by the power supply system 100 to the load 122 (e.g., to a public utility or micro grid). The control unit 134 can control as a function of for example user inputs and/or load demand schedules provided by an operator. Battery charge can be based upon market or other specified conditions, an exemplary goal being to deliver scheduled energy by optimizing cost, performance and operational information in any known fashion. The control unit 134 can, in known fashion, issue instructions to start and stop the power supply system 100, charge the energy storage system batteries, and ramp the output to meet specified demand at specified ramp rates. The gas turbine(s) can be controlled to, for example, provide a constant output and/or a desired ramp up rate in conjunction with output from the energy storage system 106. In an exemplary embodiment, the energy storage system 106 can, for example, be charged by wind, solar, geothermal, etc. energy and the power supply can provide back-up energy.

The hybrid energy system 100 may also include known power electronics associated with power conversion and balance of the load 122.

A method is also disclosed for providing power, the method including generating AC power via an AC power supply 102; supplying the power via at least first isolation transformer 104 to an output node 120; storing energy in an energy storage system 106 as DC voltage; supplying power from the energy storage system 106 to the output node 120 via a power conversion system such as a DC-to-AC converter (or an AC-to-AC frequency converter) and a step-up voltage isolation transformer 116, the energy storage system 106, DC-to-AC converter and isolation transformer 116 being connected in parallel with the AC power supply 102 and first isolation transformer 104 to the output node 120; and controlling the AC power supply 102 and the energy storage system 106 to regulate a power supplied to the output node 120.

In exemplary embodiments the output node 120 can be connected to a power utility grid as already disclosed.

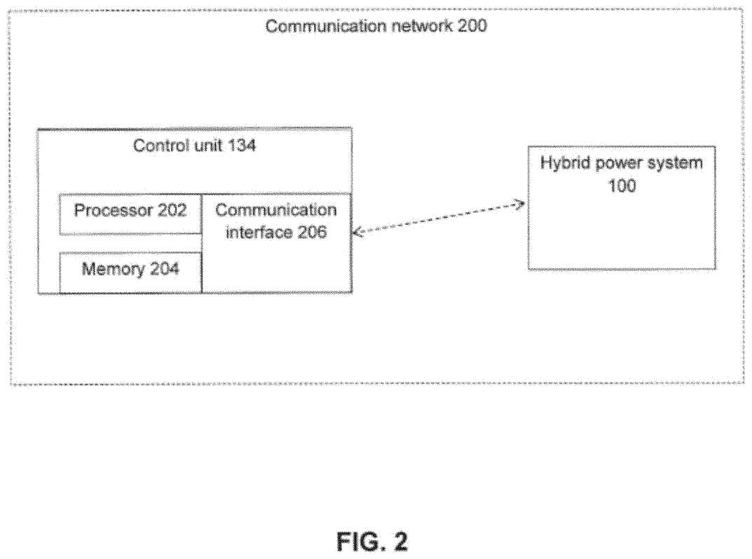

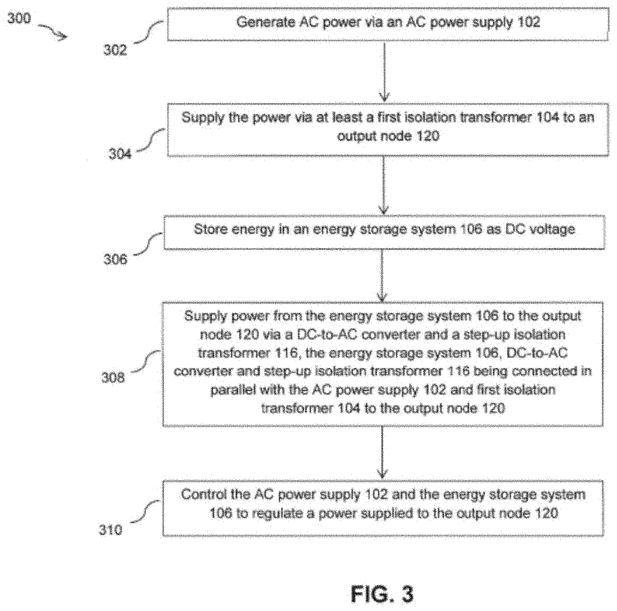

Referring FIGS. 2 and 3, embodiments can include a control unit 134 for controlling aspects of a hybrid power system 100. The exemplary control unit 134 as illustrated has a communication interface 206, at least one processor 202, and at least one memory 204 including computer program code stored thereon. The at least one memory 204 and the computer program code are configured to, with the at least one processor 202, cause the control unit 134 to implement an exemplary method 300. For instance, the processor 202 can cause the control unit 134 to carry out the following steps. Step 302 can be causing the control unit 134 to generate AC power via an AC power supply 102. Step 304 can be causing the control unit 134 to supply the power via at least a first isolation transformer 104 to an output node 120. Step 306 can be causing the control unit 134 to store energy in an energy storage system 106 as DC voltage. Step 308 can be causing the control unit 134 to supply power from the energy storage system 106 to the output node 120 via a DC-to-AC converter and a step-up isolation transformer 116, the energy storage system 106, DC-to-AC converter and step-up isolation transformer 116 being connected in parallel with the AC power supply 102 and first isolation transformer 104 to the output node 120. Step 310 can be causing the control unit 134 to control the AC power supply 102 and the energy storage system 106 to regulate a power supplied to the output node 120.

Embodiments of the processor 202 can be at least a one of a scalable processor, parallelizable processor, and optimized for multi-thread processing capabilities. In some embodiments, the processor 202 can be a graphics processing unit (GPU). In some embodiments, the processor 202 can be a supercomputer or a quantum computer whose processing power is selected as a function of anticipated network traffic (e.g. data flow). The processor 202 can include any integrated circuit or other electronic device (or collection of devices) capable of performing an operation on at least one instruction including, without limitation, Reduced Instruction Set Core (RISC) processors, CISC microprocessors, Microcontroller Units (MCUs), CISC-based Central Processing Units (CPUs), and Digital Signal Processors (DSPs). The hardware of such devices may be integrated onto a single substrate (e.g., silicon “die”), or distributed among two or more substrates. Various functional aspects of the processor 202 may be implemented solely as software or firmware associated with the processor 202.

The memory 204 can be optionally associated with the processor 202. Embodiments of the memory 204 can include a volatile memory store (such as RAM), non-volatile memory store (such as ROM, flash memory, etc.) or some combination of the two. For instance, the memory can include, but is not limited to, RAM, ROM, EEPROM, flash memory or other memory technology CDROM, digital versatile disks (DVD) or other optical storage, magnetic cassettes, magnetic tape, magnetic disk storage or other magnetic storage devices, or any other medium which can be used to store the desired information and which can accessed by the processor 202. According to exemplary embodiments, the memory 204 can be a non-transitory computer-readable medium. The term “computer-readable medium” (or “machine-readable medium”) as used herein is an extensible term that refers to any medium or any memory, that participates in providing instructions to the processor 202 for execution, or any mechanism for storing or transmitting information in a form readable by a machine (e.g., a computer). Such a medium may store computer-executable instructions to be executed by a processing element and/or control logic, and data which is manipulated by a processing element and/or control logic, and may take many forms, including but not limited to, non-volatile medium, volatile medium, and transmission media.

Transmission media includes coaxial cables, copper wire and fiber optics, including the wires that include or form a bus. Transmission media can also take the form of acoustic or light waves, such as those generated during radio-wave and infrared data communications, or other form of propagated signals (e.g., carrier waves, infrared signals, digital signals, etc.). Forms of computer-readable media include, for example, a floppy disk, a flexible disk, hard disk, magnetic tape, or any other magnetic medium, a CD-ROM, any other optical medium, punch-cards, paper-tape, any other physical medium with patterns of holes, a RAM, a PROM, and EPROM, a FLASH-EPROM, any other memory chip or cartridge, a carrier wave as described hereinafter, or any other medium from which a computer can read.

Instructions for implementation of any of the aforementioned methods can be stored on the memory 204 in the form of computer program code. The computer program code can include program logic, control logic, or other algorithms that may or may not be based on artificial intelligence (e.g., machine learning techniques, artificial neural network techniques, etc.).

In some embodiments, the control unit 134 can be part of or in connection with a communications network 200. For example, the control unit 134 can include switches, transmitters, transceivers, routers, gateways, etc. to facilitate communications via a communication protocol that facilitates controlled and coordinated signal transmission and processing. The communication links can be established by communication protocols that allow control unit 134 to form a communication interface 206. The communication interface 206 can be configured to allow the control unit 134 and another device (e.g., a computer device or processor) to form a communications network 200. For instance, the control unit 134 can be configured to communicate with a control processor (e.g., chip, expansion card, microcontroller, PID controller, etc.) associated with a component of the hybrid power system 100 and to facilitate data transmissions between the control unit 134 and at least one component of the hybrid power system 100. The communications network 200 can be configured as a long range wired or a wireless network, such as an Ethernet, telephone, Wi-Fi, Bluetooth, wireless protocol, cellular, satellite network, cloud computing network, etc. Embodiments of the communications network can be configured as a predetermined network topology. This can include a mesh network topology, a point-to-point network topology, a ring (or peer-to-peer) network topology, a star (point-to-multiple) network topology, or any combination thereof.

In addition, any of the components of the hybrid power system 100 can have an application programming interface (API) and/or other interface configured to facilitate the control unit 134 that is in communication with the component of the system 100 executing commands and controlling aspects of the system 100. Embodiments of the control unit 134 can be programmed to generate a user interface configured to facilitate control of and display of various operational aspects of the system 100.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A hybrid power system, comprising:
at least one first isolation transformer having an input configured to be connectable to an output of a power supply;
an energy storage system having at least one energy storage device and a power conversion system having at least one DC-to-AC converter connected to the at least one energy storage device; and
at least one second isolation transformer configured as a step-up isolation transformer having an input connected to an output of the storage system.

2. The hybrid power system according to claim 1, comprising:
a power supply for generating AC power.

3. The hybrid power system according to claim 2, wherein the power supply is a gas turbine generator.

4. The hybrid power system according to claim 3, wherein the power supply comprises:
plural gas turbine generators connected in parallel.

5. The hybrid power system according to claim 4, wherein the at least one first isolation transformer comprises:
plural isolation transformers, each of said isolation transformers being connected to one of the plural gas turbine generators.

6. The hybrid power system according to claim 1, wherein the energy storage system comprises:
plural energy storage devices, each of said plural energy storage devices including at least one battery module.

7. The hybrid power system according to claim 6, wherein the at least one second isolation transformer comprises:
plural isolation step-up voltage transformers, each of said plural isolation step-up voltage transformers being connected to one of plural DC-to-AC converters of the storage system.

8. The hybrid power system according to claim 1, comprising:
an output node for connecting an output of the first isolation transformer and a parallel stepped up voltage output of the second isolation transformer.

9. The hybrid power system according to claim 8, wherein the output node is a connection for supplying power of the hybrid power system to a load.

10. The hybrid power system according to claim 8, wherein the output node is a power utility grid.

11. The hybrid power system according to claim 8, comprising:
a power supply feeder protection switch and a meter connected in series between an output of the at least one first isolation transformer and the output node.

12. The hybrid power system according to claim 8, comprising:
an energy storage feeder protection switch connected in series between an output of the at least one isolation step-up voltage transformer and the output node.

13. The hybrid power system according to claim 8, comprising:
a site protection switch and a site meter connect to an output at the output node.

14. The hybrid power system according to claim 2, comprising:
a control unit for controlling outputs of the power supply and the energy storage system.

15. A method for providing power, the method comprising:
generating AC power via an AC power supply;
supplying the power via at least a first isolation transformer to an output node;
storing energy in an energy storage system as DC voltage;
supplying power from the energy storage system to the output node via a DC-to-AC converter and a step-up isolation transformer, the energy storage system, DC-to-AC converter and step-up isolation transformer being connected in parallel with the AC power supply and first isolation transformer to the output node; and
controlling the AC power supply and the energy storage system to regulate a power supplied to the output node.

16. A method for providing power, according to claim 15, wherein the output node is connected to a power utility grid.

17. A control unit for controlling a hybrid power system, comprising:
a communication interface;
at least one processor; and
at least one memory including computer program code;
the at least one memory and the computer program code configured to, with the at least one processor, cause the control unit to:
generate AC power via an AC power supply;
supply the power via at least a first isolation transformer to an output node;
store energy in an energy storage system as DC voltage;
supply power from the energy storage system to the output node via a DC-to-AC converter and a step-up isolation transformer, the energy storage system, DC-to-AC converter and step-up isolation transformer being connected in parallel with the AC power supply and first isolation transformer to the output node; and
control the AC power supply and the energy storage system to regulate a power supplied to the output node.
